(19) United States
(12) Patent Application Publication
(10) Pub. No.: US 2025/0142249 A1
(43) Pub. Date: May 1, 2025

(54) PASSIVE RADIATOR AND SPEAKER

(71) Applicant: Shenzhen Oceanwing Smart Innovations Technology Co., Ltd., Shenzhen (CN)

(72) Inventor: Hui Ding, Shenzhen (CN)

(21) Appl. No.: 18/829,843

(22) Filed: Sep. 10, 2024

(30) Foreign Application Priority Data
Oct. 27, 2023 (CN) 202311433067.X

(51) Int. Cl. H04R 1/28; H04R 1/02

(52) U.S. Cl. CPC H04R 1/2834; H04R 1/025; H04R 2400/11

(57) ABSTRACT

The present application relates to a passive radiator mechanism and a speaker box. The passive radiator mechanism includes a passive radiator assembly and a protective cover, the passive radiator assembly includes a passive vibration plate and at least two protruding portions arranged on a first surface of the passive vibration plate. The protective cover is disposed outside the passive vibration plate and is opposite to the first surface, and the protective cover is provided with a plurality of passages penetrating the protective cover. The passive vibration plate is configured to vibrate with the sound of the speaker box and can drive the protruding portions to move between a first position and a second position, and the protective cover is located between the first position and the second position. The passive radiator mechanism can protect the passive vibration plate during vibration and prevent sound blockage.

The present application claims priority to CN Application No. 202311433067.X, filed on Oct. 27, 2023. The above application is incorporated by reference in its entirety.

### TECHNICAL FIELD

The present application relates to the technical field of speaker technology, in particular to a passive radiator mechanism and a speaker box.

### BACKGROUND

With the development of speaker technology, passive basins (e.g., radiators) are widely used in the speaker system designs. Their main function is to enhance the speaker's low-frequency effects through a resonance effect with active acoustic units (e.g., speakers). In related technologies, passive radiators mainly come in two structural forms. The first is a hidden form, where the passive radiator is hidden inside a speaker box (e.g., a speaker) and is in communication with an external space through localized air vents. The overall passive radiator is barely visible from the outside, but the sound produced by low-frequency vibrations can be blocked to some extent. The second is an exposed form, where the passive radiator is mounted on an external surface of the speaker box. The passive radiator is visible from the outside, and the sound produced by low-frequency vibration is not blocked at all. However, external objects can easily press against the passive radiator, potentially blocking the vibration of the passive radiator and thus affecting sound output.

However, it is difficult for the aforementioned passive radiator structures to meet the dual requirements of both preventing the sound produced by the vibration of the passive radiator from being obstructed and providing protection to the passive radiator during the vibration process.

### SUMMARY

In a first aspect, an embodiment of the present application provides a passive radiator mechanism, which can both prevent the sound produced by the vibration of a passive radiator from being obstructed and offer protection during the vibration process of the passive radiator. The passive radiator mechanism includes:
a passive radiator assembly including a passive vibration plate and protruding portions, where the protruding portions are arranged on a first surface of the passive vibration plate, and at least two protruding portions are provided; and
a protective cover disposed outside the passive vibration plate and opposite to the first surface, where the protective cover is provided with a plurality of passages penetrating the protective cover,
where the passive vibration plate is configured to vibrate with sound of a speaker box and drive the protruding portions to move between a first position and a second position, and where the protective cover is located between the first position and the second position.

In a second aspect, an embodiment of the present application provides a speaker box, including an active acoustic unit and the passive radiator mechanism as described in the first aspect.

In a third aspect, an embodiment of the present application provides a speaker box, including an active acoustic unit and a passive radiator mechanism comprising:
a passive vibration plate having a first surface and plurality of protruding elements extending from the first surface; and
a protective cover disposed outside the passive vibration plate, the protective cover provided with a plurality of separator elements defining passages therebetween,
wherein during at least one state of use, the protruding elements of the passive vibration plate extend into respective passages in the protective cover forming an interlaced relationship.

### BRIEF DESCRIPTION OF THE DRAWINGS

FIG. 1 is a schematic diagram of an exploded view of a passive radiator mechanism in some embodiments of the present application.

FIG. 2 is a front view of the passive radiator mechanism in some embodiments of the present application.

FIG. 3 is a schematic diagram of a perspective view showing that protruding portions of the passive radiator mechanism are at a first position in some embodiments of the present application.

FIG. 4 is a cross-sectional view showing that the protruding portions of the passive radiator mechanism are at the first position in some embodiments of the present application.

FIG. 5 is a schematic diagram of a perspective view showing that the protruding portions of the passive radiator mechanism are at a second position in some embodiments of the present application.

FIG. 6 is a cross-sectional view showing that the protruding portions of the passive radiator mechanism are at the second position in some embodiments of the present application.

FIG. 7 is a schematic diagram of a perspective view showing that the protruding portions of the passive radiator mechanism are at a third position in some embodiments of the present application.

FIG. 8 is a cross-sectional view showing that the protruding portions of the passive radiator mechanism are at the third position in some embodiments of the present application.

FIG. 9 is a schematic diagram of an exploded view of the passive radiator assembly in some embodiments of the present application.

### REFERENCE NUMERALS

100. Passive radiator mechanism;
1. Passive radiator assembly; 11. Passive vibration plate; 111. First surface; 112. Second surface; 12. Protruding portion; 13. Light source; 131. Light emitting element; 132. Circuit board; 14. Radiator stand; 141. Mounting port; 142. Cavity; 143. Vent; 15. Flexible surround; 16. Connecting column; 17. Damper;
2. Protective cover; 20. Passage; 21. Cover body; 211. Opening; 212. Cover plate portion; 213. Annular connection portion; 22. Separator or separator element.

### DETAILED DESCRIPTION

In order to make the above objectives, features, and advantages of the present application more obvious and understandable, specific implementations of the present application will be described in detail below in conjunction with the accompanying drawings. In the following description, many details are set forth in order to fully understand the present application. However, the present application can be implemented in many other ways different from those described herein, and those skilled in the art can make similar improvements without violating the content of the present application. Therefore, the present application is not limited by the specific embodiments disclosed below.

In the description of the present application, it should be understood that an orientation or positional relationship indicated by the term “center”, “longitudinal”, “transverse”, “length”, “width”, “thickness”, “upper”, “lower”, “front”, “back”, “left”, “right”, “vertical”, “horizontal”, “top”, “bottom”, “internal”, “external”, “clockwise”, “counterclockwise”, “axial”, “radial”, “circumferential”, or the like is based on an orientation or positional relationship shown in the accompanying drawings, and is merely for ease of describing the present application and simplifying the description, but does not indicate or imply that an apparatus or an element referred to must have a specific orientation or be constructed and operated in a specific orientation, and therefore cannot be understood as a limitation on the present application.

In addition, the terms “first” and “second” are only for the purpose of description, and cannot be understood as indicating or implying the relative importance or implicitly indicating the quantity of the indicated technical features. Therefore, a feature defined by “first” or “second” may explicitly or implicitly include at least one such feature. In the description of the present application, “a plurality of” means at least two, such as two or three, unless otherwise specified.

In the present application, unless otherwise specified and defined, the terms “mounted”, “connected”, “connection”, “fixed”, and the like should be understood in a broad sense. For example, the “connection” may be fixed connection, detachable connection, integration, mechanical connection, electrical connection, direct connection, connection by a medium, internal communication of two elements, or interaction between two elements, unless otherwise expressly defined. Those of ordinary skill in the art can understand the specific meanings of the above terms in the present application according to specific circumstances.

In the present application, unless otherwise expressly specified and defined, that a first feature is “above” or “below” a second feature means that the first feature and the second feature are in direct contact, or are in indirect contact through a medium. Moreover, the first feature “on”, “above”, and “up” the second feature may be the first feature right above or obliquely above the second feature, or merely indicates that the level of the first feature is higher than that of the second feature. The first feature “below”, “under”, and “down” the second feature may be the first feature right below or obliquely below the second feature, or merely indicates that the level of the first feature is lower than that of the second feature.

It should be noted that when one element is referred to as being “fixed” or “arranged” on other element, the element may be directly on the other element or there is a medium element between them. When one element is considered to be “connected” to other element, the element may be directly connected to the other element or there is a medium element between them. The terms “vertical”, “horizontal”, “up”, “down”, “left”, “right”, and similar expressions used in the present application are for illustrative purposes only and do not imply unique implementations.

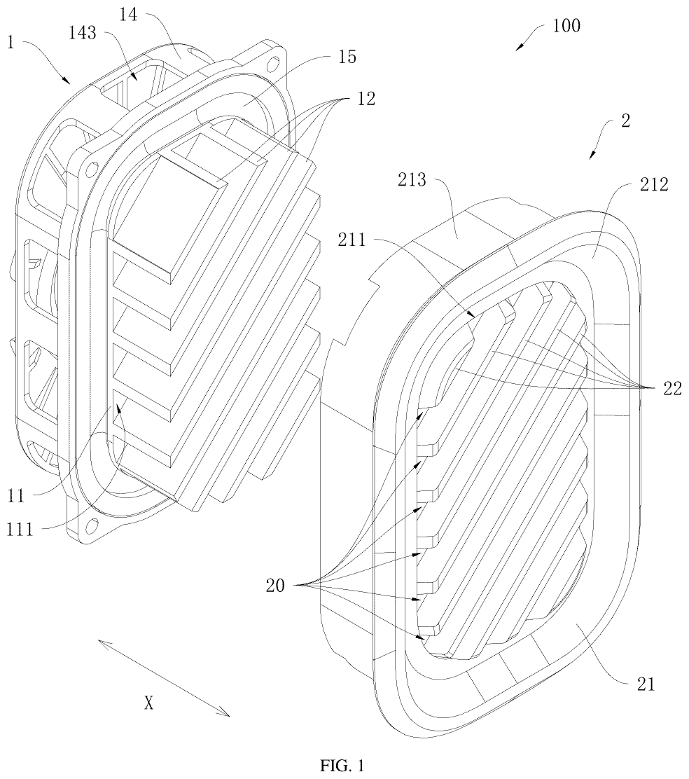

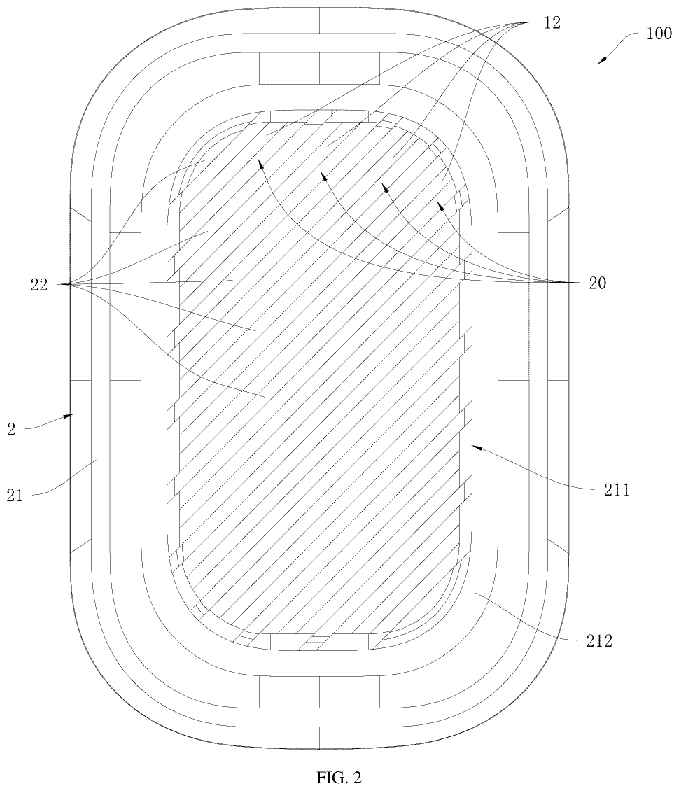

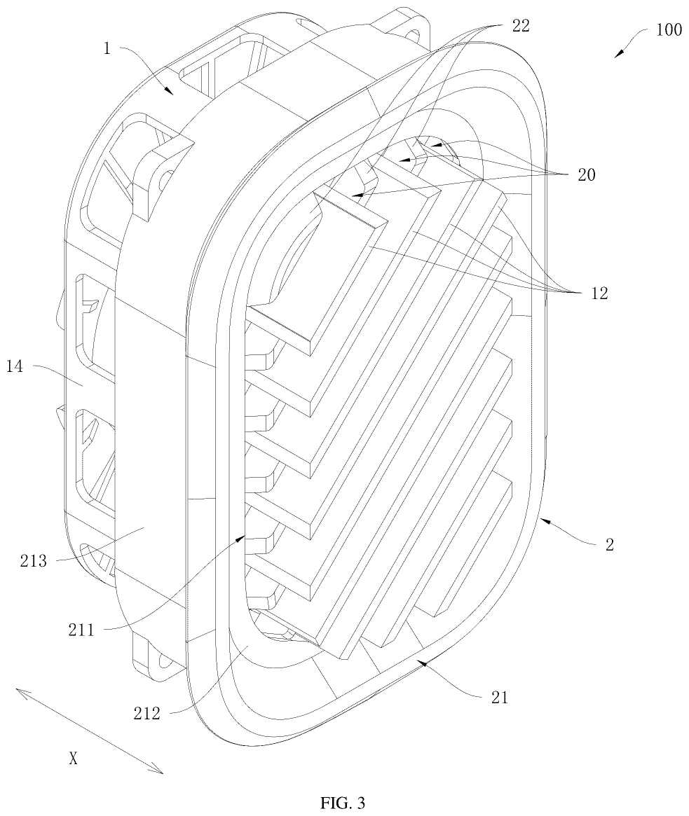

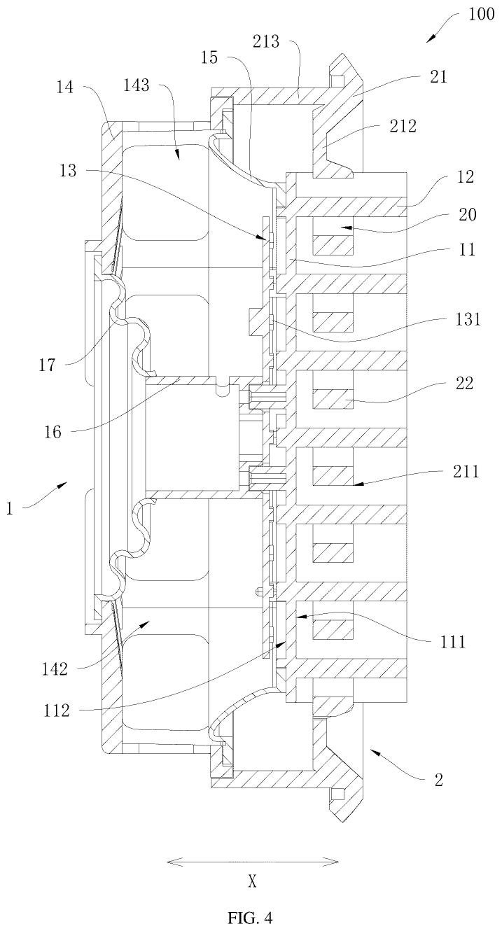

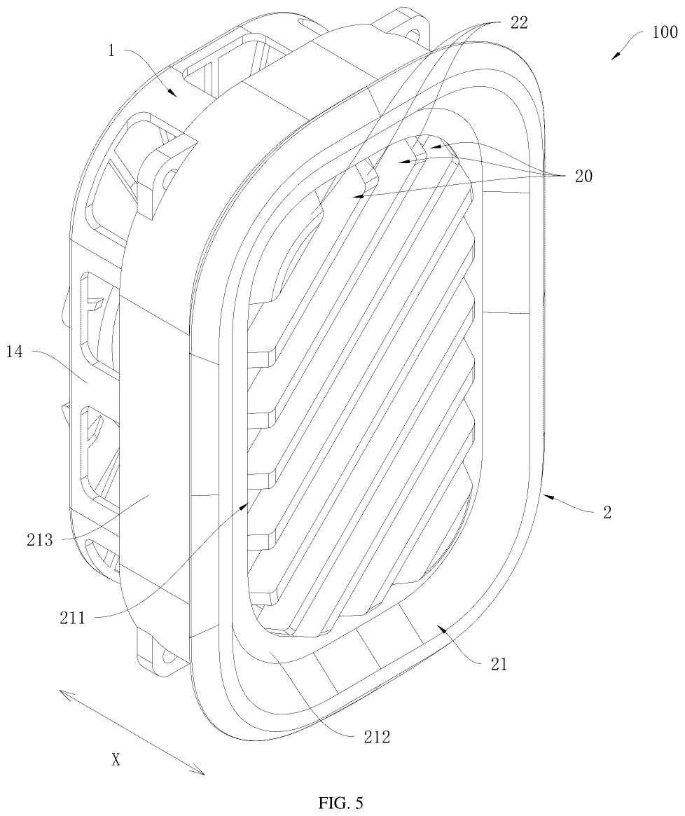

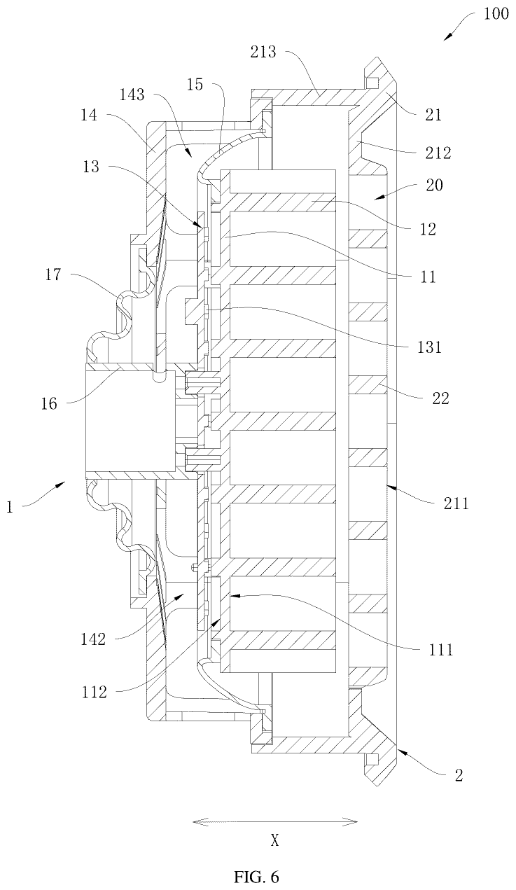

Refer to FIG. 1 to FIG. 6, where FIG. 1 is a schematic diagram of an exploded view of a passive radiator mechanism in some embodiments of the present application, FIG. 2 is a front view of the passive radiator mechanism in some embodiments of the present application, FIG. 3 is a schematic diagram of a perspective view showing that protruding portions of the passive radiator mechanism are at a first position in some embodiments of the present application, FIG. 4 is a cross-sectional view showing that the protruding portions of the passive radiator mechanism are at the first position in some embodiments of the present application, FIG. 5 is a schematic diagram of a perspective view showing that the protruding portions of the passive radiator mechanism are at a second position in some embodiments of the present application, and FIG. 6 is a cross-sectional view showing that the protruding portions of the passive radiator mechanism are at the second position in some embodiments of the present application. The present application provides a passive radiator mechanism 100. The passive radiator mechanism 100 includes a passive radiator assembly 1 and a protective cover 2, the passive radiator assembly 1 includes a passive vibration plate 11 and protruding portions 12, the protruding portions 12 are arranged on a first surface 111 of the passive vibration plate 11, and at least two protruding portions 12 are provided; the protective cover 2 is placed outside the passive vibration plate 11 and is opposite to the first surface 111, and the protective cover 2 is provided with passages 20 penetrating the protective cover 2; and the passive vibration plate 11 is configured to vibrate with the sound of a speaker box and can drive the protruding portions 12 to move between a first position and a second position, where the protective cover 2 is located between the first position and the second position.

As shown in FIGS. 1 and 3-6, the X direction represents a vibration direction of the passive vibration plate 11.

In this embodiment, the passive radiator mechanism 100 is mounted on the speaker box, where the passive vibration plate 11 of the passive radiator assembly 1 can vibrate with an active acoustic unit (such as a speaker) of the speaker box due to the resonance effect. For example, passive vibration plate 11 is configured to vibrate with the sound of the speaker box and can be used for adjusting bass, so that a designer can adjust overall tone of the speaker box to obtain higher sound quality. The passive vibration plate 11 has the first surface 111, the passive vibration plate 11 is configured to vibrate back and forth in a vibration direction, and the vibration direction intersects with the first surface 111, that is, the first surface 111 is not parallel to the vibration direction of the passive vibration plate 11. When the passive radiator assembly 1 is mounted on the speaker box, the first surface 111 of the passive vibration plate 11 faces an outer side of the speaker box, so that the passive vibration plate 11 can vibrate towards the outer side of the speaker box. The shape of the first surface 111 may be various, such as rectangular, circular, elliptical, or regular polygonal, without limitation herein. The first surface 111 may be a plane, that is, the passive vibration plate 11 may be a flat plate, or the first surface 111 may be a curved surface, such as an arc-shaped surface, that is, the passive vibration plate 11 may be an arc-shaped panel, without limitation herein. The passive vibration plate 11 may be manufactured from various materials, such as plastic and composite materials, without limitation herein. Optionally, the first surface 111 is a plane perpendicular to the vibration direction of the passive vibration plate 11, that is, the vibration direction is perpendicular to the first surface 111.

At least two protruding portions 12 are provided on the first surface 111 of the passive vibration plate 11. For example, at least four protruding portions or elements are provided on the first surface 111. Specifically, a proximal end of the protruding portion 12 is fixedly connected to the first surface 111 of the passive vibration plate 11, and a distal end of the protruding portion 12 extends in a direction away from the passive vibration plate 11 in the vibration direction of the passive vibration plate 11. That is, the protruding portion 12 is generally in a shape with a certain height in the vibration direction of the passive vibration plate 11, and may be in a column shape, such as a cylinder, a rectangular column, or a polygonal column, or a plate shape, such as a flat plate or an arc-shaped plate, without limitation here. The protruding portion 12 may be made of the same material as the passive vibration plate 11, or a different material from the passive vibration plate 11, without limitation herein. The quantity of protruding portions 12 may be two, three, four . . . tens, etc., without limitation herein. The plurality of protruding portions 12 may be arranged linearly side by side, arranged in an array, or arranged irregularly, without limitation herein. Optionally, the protruding portions 12 are integrally formed with the passive vibration plate 11.

The protective cover 2 is placed outside the passive vibration plate 11 and is opposite to the first surface 111, a vibration chamber is enclosed between the protective cover 2 and the passive vibration plate 11, and the vibration chamber facilitates the vibration of the passive vibration plate 11. Meanwhile, the protective cover 2 is provided with passages 20 penetrating the protective cover 2. Specifically, the passages 20 penetrate an inner side and an outer side of the protective cover 2, where the inner side of the protective cover 2 refers to a side close to the passive vibration plate 11, and the outer side of the protective cover 2 refers to a side away from the passive vibration plate 11. Therefore, the passages 20 are in communication with the vibration chamber to facilitate passing of airflow generated in the vibration process of the passive vibration plate 11, so as to achieve vibration sound production. The protective cover 2 can protect the passive vibration plate 11, namely, prevent external objects from being squeezed onto the passive vibration plate 11 to block the vibration of the passive vibration plate 11 and affect its sound production, thereby achieving protection in the vibration process of the passive vibration plate 11; and the protective cover can also prevent the sound produced by the low-frequency vibration of the passive vibration plate 11 from being blocked, to ensure that the sound quality is not affected and the passive radiator mechanism 100 has better low-frequency resonance sound production effect. When the passive radiator assembly 1 is mounted on the speaker box, the first surface 111 of the passive vibration plate 11 faces the outer side of the speaker box, and the passive vibration plate 11 can be seen from the outside. Meanwhile, the protective cover 2 is placed outside the passive vibration plate 11 to shield the passive radiator assembly 1. Therefore, the passive radiator mechanism 100 of the present application is semi-hidden, between a hidden form and an exposed form. Optionally, the protective cover 2 is fixedly connected to the passive radiator assembly 1.

Further, when the passive vibration plate 11 vibrates with the sound of the speaker box, the protruding portions 12 on the first surface 111 can be driven to move synchronously. Specifically, the passive vibration plate 11 has a positive amplitude state and a negative amplitude state, a positive amplitude direction of the passive vibration plate 11 is the same as an orientation of the first surface 111, and correspondingly, the protruding portions 12 can move between the first position and the second position. The first position and the second position are positions of the protruding portions 12 corresponding to a maximum amplitude of the passive vibration plate 11. That is, when the passive vibration plate 11 is in a maximum positive amplitude state, the protruding portions 12 correspond to the first position; and when the passive vibration plate 11 is in a maximum negative amplitude state, the protruding portions 12 correspond to the second position. The protective cover 2 is located between the first position and the second position, that is, the first position and the second position are on two opposite sides of the protective cover 2. The first position is on a side, away from the passive vibration plate 11, of the protective cover 2, that is, the first position is on the outer side of the protective cover 2, and the second position is on a side, close to the passive vibration plate 11, of the protective cover 2, that is, the second position is on the inner side of the protective cover 2. Accordingly, the vibration of the passive vibration plate 11 can drive the protruding portions 12 to pass through the passages 20 on the protective cover 2 forming an interlaced relationship and extend to the outer side of the protective cover 2 or retract to the inner side of the protective cover 2.

As shown in FIG. 3 and FIG. 4, the protruding portions 12 are close to the first position, and the passive vibration plate 11 is in the positive amplitude state. In this case, the vibration amplitude of the passive vibration plate 11 is close to the protective cover 2, the protruding portions 12 pass through the passages 20 on the protective cover 2, a distal end of the protruding portion 12 extends from the passage 20 to the outer side of the protective cover 2, and it can be seen from the outer side of the protective cover 2 that the protruding portions 12 clearly extend out of the passages 20 on the protective cover 2. The distal end of the protruding portion 12 refers to an end, away from the first surface 111, of the protruding portion 12.

As shown in FIG. 5 and FIG. 6, the protruding portions 12 are close to the second position, and the passive vibration plate 11 is in the negative amplitude state. In this case, the vibration amplitude of the passive vibration plate 11 is far away from the protective cover 2, the protruding portions 12 are far away from the passages 20 on the protective cover 2, the protruding portions 12 are overall located on the inner side of the protective cover 2, and the passages 20 on the protective cover 2 can be seen from the outer side of the protective cover 2.

When the passive vibration plate 11 continuously vibrates back and forth, the protruding portions 12 on the first surface 111 are driven to move back and forth cyclically. The sound produced by the speaker box is loud or low, and the real-time amplitude of the passive vibration plate 11 is related to the volume of the sound, which does not exceed the maximum amplitude, so that the protruding portions 12 can move back and forth to the first position and the second position, or return midway towards the first position and the second position. From the outside of the protective cover 2, it can be seen that visible portions of the protruding portions 12 vary to present a varying visual effect. The vibration frequency of the passive vibration plate 11 is negatively correlated to its vibration amplitude. The lower the vibration frequency, the greater the vibration amplitude of the passive vibration plate 11. For example, the vibration frequency of the passive vibration plate 11 is between 20 Hz and 150 Hz. Therefore, when the passive radiator mechanism 100 is used, a visual effect can be presented correspondingly according to audios output by the active acoustic unit to meet personalized usage requirements.

The passive radiator mechanism 100 in the embodiment of the present application, provided with the protective cover 2 having the passages 20, can prevent external objects from being squeezed onto the passive vibration plate 11 to block the vibration of the passive vibration plate 11 and affect sound production, and can also prevent the sound produced by the low-frequency vibration of the passive vibration plate 11 from being blocked, so the passive radiator mechanism 100 has a better low-frequency resonance sound production effect, and the sound quality is not affected while the passive vibration plate 11 is protected. Therefore, the passive radiator mechanism 100 can not only prevent the sound produced by the vibration of a passive radiator from being blocked, but also protect the passive radiator during vibration.

Meanwhile, at least two protruding portions 12 are provided on the first surface 111 of the passive vibration plate 11 to cooperate with the passages 20 on the protective cover 2, the passive vibration plate 11 drives the protruding portions 12 to move relative to the passages 20 on the protective cover 2 when vibrating, and it can be seen from the outside of the protective cover 2 that the visible portions of the protruding portions 12 vary. Therefore, when the passive radiator mechanism 100 is used, a visual effect can be presented correspondingly according to the audios output by the active acoustic unit, thereby improving the sense of technology and aesthetics of the product and improving both the reflected music effect and the displayed visual effect to meet personalized usage requirements.

In some embodiments, with reference to FIG. 1 and FIG. 2, shapes of projection contours of the plurality of protruding portions 12 on the first surface 111 include at least one of regular and irregular shapes.

In this embodiment, the regular shape refers to a shape with clear definition and name, such as rectangle, circle, ellipse, triangle, parallelogram, trapezoid, regular polygon, semicircle, pentagon, or crescent, without limitation herein. The irregular shape refers to a shape that cannot be clearly defined or named, such as a shape enclosed by connecting a plurality of arcs and straight lines end to end, or a text contour. The projection contours of the plurality of protruding portions 12 on the first surface 111 include at least one of regular and irregular shapes, that is, the projection contours of the plurality of protruding portions 12 may all be in regular or irregular shapes, or in both regular and irregular shapes; the shapes of the projection contours of the protruding portions 12 may be all the same or different, or some of them may be the same and the other may be different; and the shapes of the projection contours of the plurality of protruding portions 12 on the first surface 111 can be flexibly selected as needed. Specifically, the projection of the protruding portion 12 on the first surface 111 refers to a projection of the protruding portion 12 in the vibration direction on the first surface 111.

The projection contours of the plurality of protruding portions 12 on the first surface 111 can be flexibly selected between multiple regular and irregular shapes, so that the plurality of protruding portions 12 can present multiple identical or different visual effects, more attractive visual effects can be shown, and the aesthetics of the product is further improved.

In some embodiments, with reference to FIG. 1 and FIG. 2, the projections of the plurality of protruding portions 12 on the first surface 111 are arranged to form a preset pattern.

In this embodiment, the preset pattern is preset and may be a variety of graphic patterns, such as grid bars, grid dots, spirals, flower shapes, a trademark, or a logo, without limitation here. By arranging the projections of the plurality of protruding portions 12 on the first surface 111 to form a preset pattern, a visual varying effect of the preset pattern can be presented with easy recognition and a more attractive visual effect.

In some specific embodiments, with reference to FIG. 1 and FIG. 2, the projection contours of the plurality of protruding portions 12 on the first surface 111 are all in a shape of strips, such as rectangular or trapezoidal strips; and the strip-shaped projections of the plurality of protruding portions 12 are arranged side by side along a diagonal direction of the first surface 111, so that the projections of the plurality of protruding portions 12 on the first surface 111 are arranged to form a grid shape, that is, the plurality of protruding portions 12 are arranged to form a grid plate.

In some embodiments, the plurality of protruding portions 12 have the same height in the vibration direction. By designing the plurality of protruding portions 12 at the same height, the plurality of protruding portions 12 can display a neat visual effect.

In other embodiments, the plurality of protruding portions 12 have different heights in the vibration direction. By designing the plurality of protruding portions 12 at different heights, more diverse pattern changes can be designed to show more diverse visual effects and meet personalized usage requirements.

In some embodiments not shown, one passage 20 is provided. When the passive vibration plate 11 vibrates, the plurality of protruding portions 12 move in and out relative to the protective cover 2 through the passage 20, showing a visual effect change caused by the back-and-forth movement of the preset pattern formed by the arrangement of the plurality of protruding portions 12.

In other embodiments, with reference to FIG. 1 and FIG. 2, a plurality of passages 20 are provided, and the plurality of passages 20 correspond with the plurality of protruding portions 12 one to one.

In this embodiment, the protective cover 2 is provided with a plurality of passages 20, and the plurality of passages 20 correspond with the plurality of protruding portions 12 one to one, that is, each passage 20 is opposite to a protruding portion 12 in the vibration direction, so that the vibration of the passive vibration plate 11 drives the plurality of protruding portions 12 to pass through the plurality of passages 20 on the protective cover 2 one to one. The plurality of protruding portions 12 on the first surface 111 and the plurality of passages 20 on the protective cover 2 move relatively in a staggered manner, which presents a complex and diverse visual effect and a more attractive visual effect.

In some embodiments, with reference to FIG. 1 and FIG. 2, the shape of a projection contour of the passage 20 on the first surface 111 is adapted to that of the projection contour of the protruding portion 12 on the first surface 111.

In this embodiment, the shape of the projection contour of the passage 20 on the first surface 111 is adapted to that of the projection contour of the protruding portion 12 on the first surface 111, which means that the shape of the projection contour of the passage 20 on the first surface 111 is substantially the same as that of the projection contour of the protruding portion 12 on the first surface 111, so that the protruding portion 12 easily passes through the passage 20 to avoid interfering the relative movement between the protruding portion 12 and the protective cover 2. In addition, the cooperative movement of the protruding portion 12 and the passage 20 makes the visual effect better and the aesthetics higher.

In some embodiments not shown, the passage 20 is a through hole formed on the protective cover 2, and there is a gap between an inner wall of the through hole and a peripheral wall of the protruding portion 12. There is a gap between the inner wall of the through hole and the peripheral wall of the protruding portion 12, which means that there is a gap between the inner wall of the through hole and the peripheral wall of the protruding portion 12 when the protruding portion 12 passes through the through hole. By forming the gap between the inner wall of the through hole and the peripheral wall of the protruding portion 12, the protruding portion 12 moves within the through hole, thereby effectively preventing the protruding portion 12 from rubbing or colliding with the inner wall of the through hole, avoiding interfering the vibration of the passive vibration plate 11 to affect sound production, and protecting the sound quality from being affected.

In other embodiments, with reference to FIG. 1 and FIG. 2 and further reference to FIG. 4 and FIG. 6, the protective cover 2 includes a cover body 21 and separators or separator elements 22, the cover body 21 is provided with an opening 211, the separators 22 are arranged at the opening 211 and connected to the cover body 21, the separators 22 separate the opening 211 to form the plurality of passages 20, and there is a gap between the peripheral wall of the protruding portion 12 and the separators 22 as well as the inner wall of the opening 211. For example, the cover body 21 includes at least two separators.

In this embodiment, a larger opening 211 is formed on the cover body 21, and all the protruding portions 12 can pass through the opening 211 simultaneously; meanwhile, the separators 22 are provided to separate the opening 211 into a plurality of portions, and two adjacent separators 22 and the inner wall of the opening 211 jointly enclose a passage 20; and there is a gap between the peripheral wall of the protruding portion 12 and the separators 22 as well as the inner wall of the opening 211, which means that when the protruding portion 12 passes through the passage 20, there is a gap between the peripheral wall of the protruding portion 12 and the two separators 22 corresponding to the passage 20 as well as the inner wall of the opening 211. In this way, the protruding portion 12 moves within the passage 20, thereby effectively preventing the protruding portion 12 from rubbing or colliding with the cover body 21 or the separators 22, avoiding interfering the vibration of the passive vibration plate 11 to affect sound production, and protecting the sound quality from being affected.

In some embodiments, the width of the gap is between 2 millimeters and 3 millimeters.

In this embodiment, the width of the gap refers to the distance between the inner wall of the through hole and the peripheral wall of the protruding portion 12, or the distance between the peripheral wall of the protruding portion 12 and the separators 22 as well as the inner wall of the opening 211. Understandably, when the protruding portion 12 passes through the passage 20, the gap is in a ring shape around the peripheral wall of the protruding portion 12. The width of the gap, on the one hand, affects the smoothness of passing of the protruding portion 12 through the passage 20, and on the other hand, affects the visual effect shown when the protruding portion 12 moves. The width of the gap is between 2 millimeters and 3 millimeters, which can effectively prevent the protruding portion 12 from rubbing or colliding with the protective cover 2 when passing through the passage 20 to ensure smoother movement of the protruding portion 12, and is also conducive to presenting an attractive visual effect.

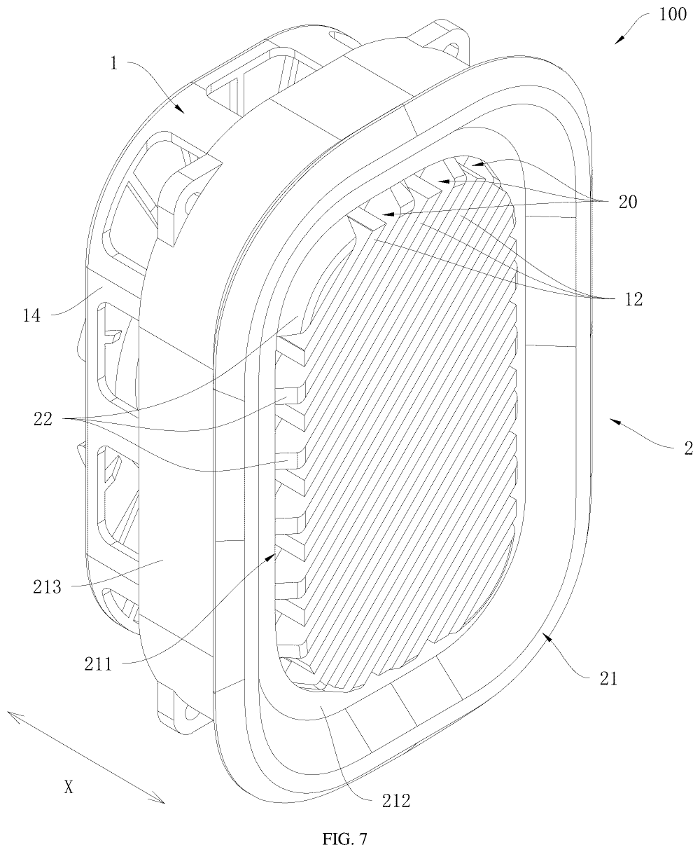

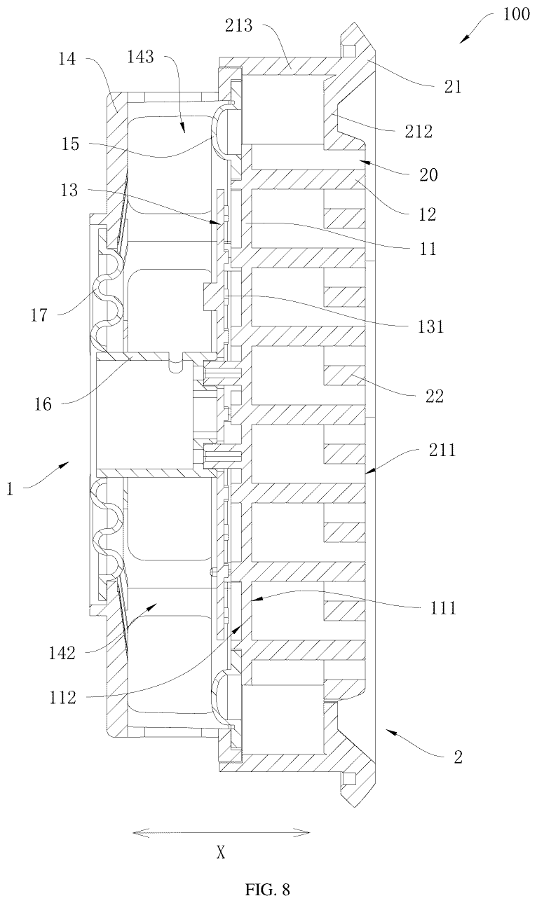

In some embodiments, refer to FIG. 7 and FIG. 8, where FIG. 7 is a schematic diagram of a perspective view showing that the protruding portions of the passive radiator mechanism are at a third position in some embodiments of the present application, and FIG. 8 is a cross-sectional view showing that the protruding portions of the passive radiator mechanism are at the third position in some embodiments of the present application. The passive vibration plate 11 is configured to be able to drive the protruding portions 12 to move to the third position, where at the third position, an end surface, away from the passive vibration plate 11, of the protruding portion 12 is flush with an end surface, away from the passive vibration plate 11, of the passage 20, and the third position is between the first position and the second position.

In this embodiment, the protruding portions 12 can move to the third position, and the third position is between the first position and the second position. In this case, the passive vibration plate 11 has no vibration amplitude, the passive vibration plate 11 is in a zero amplitude state, the distal end of the protruding portion 12 is located in the passage 20, and it can be seen from the outer side of the protective cover 2 that the protruding portion 12 is substantially flush with the end surface of the passage 20 on the protective cover 2. Generally, when the passive radiator mechanism 100 is not working, the passive vibration plate 11 is in the zero amplitude state, the protruding portions 12 are located at the third position, the distal ends of the plurality of protruding portions 12 are located in the plurality of passages 20 respectively, and the end surfaces, away from the passive vibration plate 11, of the plurality of protruding portions 12 are flush with the end surfaces, away from the passive vibration plate 11, of the passages 20.

By configuring the end surfaces, away from the passive vibration plate 11, of the plurality of protruding portions 12 to be flush with the end surfaces, away from the passive vibration plate 11, of the passages 20 in the zero amplitude state, the protruding portions 12 are prevented from being squeezed by the outside to damage the passive vibration plate 11 when the passive radiator mechanism 100 is not used, storage and transportation are facilitated, and the outside of the protective cover 2 has a relatively flat visual effect in the zero amplitude state to improve the aesthetics.

In some specific embodiments, with reference to FIGS. 1 to 8, the separators 22 are grid bars, and the passage 20 is a bar-type grid hole enclosed by two adjacent grid bars and the inner wall of the opening 211. The grid bars on the passive vibration plate 11 and the grid bars on the protective cover 2 cooperatively move in a staggered manner, which can show a more attractive visual effect. In addition, the grid holes further reduce the blocking on the sound produced by the low-frequency vibration of the passive vibration plate 11, which is conducive to reflecting the music effect with high fidelity. Optionally, two opposite ends of the grid bar in the vibration direction extend out of two opposite ends of the cover body 21, so the end surface, away from the passive vibration plate 11, of the passage 20 refers to an end surface, away from the passive vibration plate 11, of the separator 22.

In some embodiments, the passive vibration plate 11 includes a light-transmitting material component, and/or the protruding portion 12 includes a light-transmitting material component.

In this embodiment, the light-transmitting material refers to a material that can transmit light, for example, the light-transmitting material may be glass, organic glass, etc. The passive vibration plate 11 may be a light-transmitting material component, or the protruding portion 12 is a light-transmitting material component, or both the passive vibration plate 11 and the protruding portion 12 are light-transmitting material components. By configuring the passive vibration plate 11 and/or the protruding portion 12 as light-transmitting material components, the passive vibration plate 11 and/or the protruding portion 12 can transmit light. Therefore, when a light emitting apparatus is provided in the passive radiator mechanism 100 or the speaker box, the light emitted by the light emitting apparatus can be emitted outward through the passive vibration plate 11 and/or the plurality of protruding portions 12. This can enhance the visual effect of relative movement between the protruding portions 12 and the protective cover 2, and is conducive to avoiding an unapparent visual effect of relative staggered movement of the protruding portions 12 and the protective cover 2 in a case that the colors of the surfaces of the protective cover 2 and the protruding portions 12 are dark or in a dark environment. In addition, light can be equipped synchronously or asynchronously according to the output audios, thereby increasing recognition of different sound ranges in various usage scenarios, and further enhancing the aesthetic experience of the product.

Optionally, both the passive vibration plate 11 and the protruding portion 12 may be transparent or semi-transparent material components.

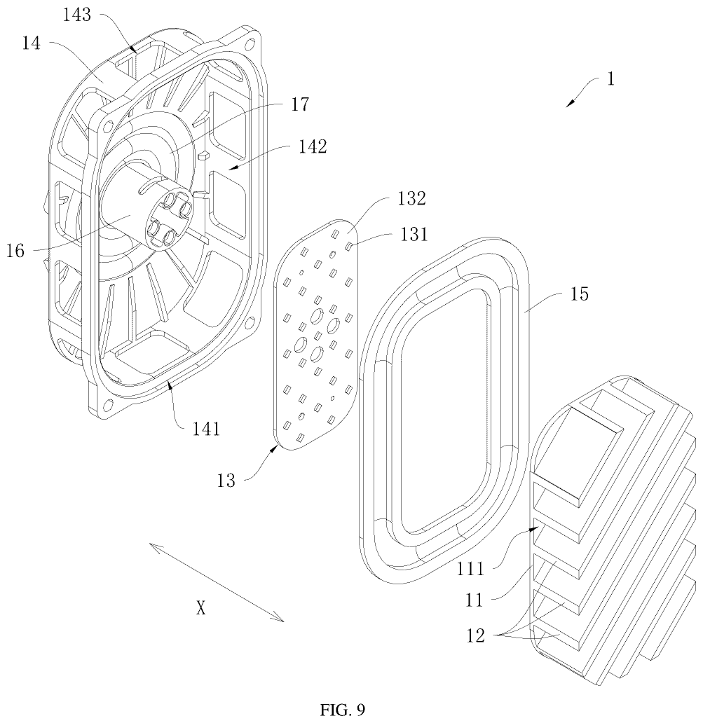

In some embodiments, refer to FIGS. 6 to 8, and further refer to FIG. 9, where FIG. 9 illustrates a schematic diagram of an exploded view of the passive radiator assembly in some embodiments of the present application. The passive radiator assembly 1 further includes a light source 13, and the light source 13 is arranged on the passive vibration plate 11.

In this embodiment, the light source 13 is used for emitting light. The light source 13 is arranged on the passive vibration plate 11, and the light source 13 emits light to form a lighting effect, which can illuminate the protruding portions 12 and the protective cover 2 and is conducive to avoiding an unapparent visual effect of relative staggered movement of the protruding portions 12 and the protective cover 2 in a case that the colors of the surfaces of the protective cover 2 and the protruding portions 12 are dark or in a dark environment. In addition, when the passive vibration plate 11 vibrates, the light source 13 can be driven to move synchronously, which can present the lighting effect according to the output audios to show a more attractive visual effect and further enhancing the sense of technology and aesthetics of the product.

Specifically, with reference to FIGS. 4, 6, 8, and 9, the passive vibration plate 11 further has a second surface 112 opposite to the first surface 111, and the light source 13 is mounted on the second surface 112.

In this embodiment, the light source 13 is arranged on a back surface of the passive vibration plate 11 to emit light, and both the passive vibration plate 11 and the protruding portions 12 are light-transmitting material components; because both the passive vibration plate 11 and the protruding portions 12 can transmit light, the light source 13 is mounted on the second surface 112 of the passive vibration plate 11, the light emitted by the light source 13 can be emitted outward through the passive vibration plate 11 and the protruding portions 12, and the light is dispersed uniformly, resulting in a better visual effect; and the light source 13 can be prevented from being exposed on the outer side of the passive vibration plate 11, which is beneficial to protecting the light source 13 and prolonging its service life.

In some embodiments, with reference to FIGS. 4, 6, 8, and 9, the light source 13 includes a plurality of light emitting elements 131, and the light emitting elements 131 are misaligned with the protruding portions 12.

In this embodiment, the light emitting elements 131 refer to elements that can actively emit light, such as light emitting diodes; and the light emitting elements 131 are misaligned with the protruding portions 12, which means that projections of the light emitting elements 131 on the passive vibration plate 11 are misaligned with projections of the protruding portions 12 on the passive vibration plate 11. Specifically, the plurality of protruding portions 12 on the passive vibration plate 11 are spaced apart from each other, and each protruding portion 12 can correspondingly pass through a passage 20. The light emitting elements 131 are misaligned with the protruding portions 12, that is, the light emitting elements 131 are arranged opposite to spacing areas on the passive vibration plate 11, so that the light emitting elements 131 emit light towards the spacing areas on the passive vibration plate 11. Then, the light is transmitted by the passive vibration plate 11 to the protruding portions 12 to form uniform light, making the light emitted through the protruding portions 12 softer and more uniform. The plurality of light emitting elements 131 are configured to emit light towards the plurality of spacing areas on the passive vibration plate 11, which is beneficial to improving the brightness and range of light emission. Moreover, the emitted light is dispersed uniformly, making the lighting visual effect better and further improving the sense of technology and aesthetics.

In some specific embodiments, as shown in FIG. 9, the light emitting elements 131 are LEDs (Light Emitting Diodes), the light source 13 is a PCBA (Printed Circuit Board Assembly) assembled with LEDs, the light source 13 further includes a circuit board 132, a plurality of LED beads are arranged on the circuit board 132, and the circuit board 132 is fixedly mounted on the second surface 112 of the passive vibration board 11.

In some embodiments, with reference to FIGS. 4, 6, 8, and 9, the passive radiator assembly 1 further includes a radiator stand 14 and a flexible surround 15, the radiator stand 14 is provided with a mounting port 141, an inner ring side of the flexible surround 15 is connected to the periphery of the passive vibration plate 11, and an outer ring side of the flexible surround 15 is connected to an inner side of the mounting port 141 to arrange the passive vibration plate 11 at the mounting port 141.

In this embodiment, the passive vibration plate 11 and the flexible surround 15 jointly seal the mounting port 141 of the radiator stand 14, and the passive vibration plate 11 is mounted in the speaker box through the radiator stand 14 and the flexible surround 15. Because the flexible surround 15 is made of a flexible material, the passive vibration plate 11 produces vibrations of different frequencies and amplitudes in response to the resonance effect of the active acoustic unit.

Optionally, the radiator stand 14 may be made of a metal material, such as aluminum or stainless steel, or the radiator stand 14 may be made of a non-metallic material, such as plastic or composite, without limitation here. In some specific embodiments, the flexible surround 15 is a rubber R-ring.

Optionally, the passive vibration plate 11 is fixed to the flexible surround 15 and the flexible surround 15 is fixed to the radiator stand 14 by adhesive bonding.

In some embodiments, with reference to FIGS. 4, 6, 8, and 9, the passive radiator assembly 1 further includes a connecting column 16 and a damper 17, the radiator stand 14 has a cavity 142 inside, the cavity 142 is in communication with the mounting port 141, the connecting column 16 is arranged inside the cavity 142 and connected to the passive vibration plate 11 at one end, the damper 17 is of a ring structure, an inner ring side of the damper 17 is connected to the other end of the connecting column 16, and an outer ring side of the damper 17 is connected to the radiator stand 14.

In this embodiment, the radiator stand 14 is constructed as a radiator-shaped structure with a cavity 142 inside and an open end, and a resonant cavity is enclosed by the radiator stand 14, the passive vibration plate 11, and the flexible surround 15; the passive vibration plate 11 is connected to the radiator stand 14 through the connecting column 16 and the damper 17, and the damper 17 is used for supporting the connecting column 16 and preventing the connecting column 16 from moving laterally, thereby limiting the vibration of the passive vibration plate 11; and the damper 17 made of a flexible material can cooperate with the flexible surround 15, so that the passive vibration plate 11 produces different vibration frequencies and amplitudes due to the resonance effect with the active acoustic unit, the resonance effect is better, and the sound quality of the passive radiator mechanism 100 can be improved.

Optionally, the passive vibration plate 11 is coaxial with the connecting column 16. The connecting column 16 is connected and fixed to the damper 17 and the radiator stand 14 through an adhesive.

Optionally, the cross-section of the damper 17 is wrinkled.

Optionally, the light source 13 can be clamped and fixed between the passive vibration plate 11 and the connecting column 16 stably and reliably; and the interior of the connecting column 16 is a hollow structure, which facilitates wiring of the light source 13 and mounting.

In some embodiments, with reference to FIGS. 4, 6, 8, and 9, vents 143 are formed on a side wall of the radiator stand 14, and the vents 143 are in communication with the cavity 142.

Specifically, a plurality of vents 143 are provided on four side walls of the radiator stand 14. By providing the vents 143, the resonant cavity inside the passive radiator assembly 1 can be in communication with the active acoustic unit, which is conducive to the vibration of the passive vibration plate 11 due to the resonance effect with the active acoustic unit, and is conducive to reducing energy loss and improving sound quality.

In some embodiments, with reference to FIGS. 1 and 3 to 8, the protective cover 2 includes a cover body 21, the cover body 21 has a cover plate portion 212 and an annular connection portion 213, the passage 20 is constructed on the cover plate portion 212, one end of the annular connection portion 213 is connected to the cover plate portion 212, and the other end of the annular connection portion 213 is buckled and connected to an end, provided with the mounting port 141, of the radiator stand 14.

In this embodiment, the protective cover 2 is buckled and connected to the open end, provided with the mounting port 141, of the radiator stand 14 through the annular connection portion 213, so as to detachably mount the protective cover 2 on the passive radiator assembly 1, making disassembly and assembly simple.

The present application provides a speaker box. The speaker box includes an active acoustic unit and the passive radiator mechanism 100 provided by any of the above embodiments. Optionally, the active acoustic unit may be a speaker.

The speaker box has the same technical effects as the passive radiator mechanism 100, so details are not repeated here.

In some embodiment, the present application provides a speaker box including an active acoustic unit and a passive radiator mechanism. The passive radiator mechanism comprising comprises a passive vibration plate having a first surface and plurality of protruding elements extending from the first surface; and a protective cover disposed outside the passive vibration plate, the protective cover provided with a plurality of separator elements defining passages therebetween. During at least one state of use, the protruding elements of the passive vibration plate extend into respective passages in the protective cover forming an interlaced relationship. The speaker box may comprise at least four protruding elements and at least four separator elements, where the protruding elements and the separator elements are parallel to each other. During a second state of use, the protruding elements do not extend into the respective passages.

The technical features of the above embodiments can be combined arbitrarily. For the purpose of simplicity in description, all possible combinations of the technical features in the above embodiments are not described. However, as long as the combinations of these technical features do not have contradictions, they shall fall within the scope of the description.

The above embodiments describe only several implementations of the present application, and their descriptions are specific and detailed, but cannot therefore be understood as limitations to the patent scope of the present application. It should be noted that those of ordinary skill in the art can make some variations and improvements without departing from the concept of the present application, and these variations and improvements all fall into the protection scope of the present application. Therefore, the patent protection scope of the present application should be subject to the appended claims.

What is claimed is:

1. A passive radiator mechanism, comprising:
a passive radiator assembly comprising a passive vibration plate and at least two protruding portions, wherein the at least two protruding portions are arranged on a first surface of the passive vibration plate; and
a protective cover disposed outside the passive vibration plate and opposite to the first surface, wherein the protective cover is provided with a plurality of passages penetrating the protective cover.

2. The passive radiator mechanism according to claim 1, wherein the passive vibration plate is configured to vibrate with sound of a speaker box to drive the at least two protruding portions to move between a first position and a second position, and wherein the protective cover is disposed between the first position and the second position.

3. The passive radiator mechanism according to claim 2, wherein when the passive vibration plate continuously vibrates back and forth, and wherein the at least two protruding portions on the first surface are driven to move back and forth between the first position and the second position.

4. The passive radiator mechanism according to claim 2, wherein when the passive vibration plate vibrates with the sound of the speaker box, the at least two protruding portions on the first surface are driven to move synchronously between the first position and the second position, wherein the passive vibration plate has a positive amplitude state and a negative amplitude state, and wherein a positive amplitude direction of the passive vibration plate is same as an orientation of the first surface.

5. The passive radiator mechanism according to claim 2, wherein the first position and the second position are positions of the at least two protruding portions corresponding to a maximum amplitude of the passive vibration plate, wherein the at least two protruding portions are correspondingly located at the first position when the passive vibration plate is in a maximum positive amplitude state, and the protruding portions are correspondingly located at the second position when the passive vibration plate is in a maximum negative amplitude state.

6. The passive radiator mechanism according to claim 2, wherein when the passive vibration plate vibrates, a distal end of a protruding portion of the at least two protruding portions is driven to pass through a passage of the plurality of passages on the protective cover and extend to an outer side of the protective cover or retract to an inner side of the protective cover.

7. The passive radiator mechanism according to claim 6, wherein the first position and the second position are on two opposite sides of the protective cover, and wherein:
the first position is on a side, away from the passive vibration plate, of the protective cover, that is, the first position is on an outer side of the protective cover, and the second position is on a side, close to the passive vibration plate, of the protective cover, that is, the second position is on an inner side of the protective cover, so that when the passive vibration plate vibrates, the distal end of a protruding portion is driven to pass through a passage on the protective cover and extend to the outer side of the protective cover or retract to the inner side of the protective cover.

8. The passive radiator mechanism according to claim 6, wherein the distal end of the protruding portion corresponds to an end, away from the first surface, of the protruding portion.

9. The passive radiator mechanism according to claim 1, wherein projections of the at least two protruding portions on the first surface are arranged to form a preset pattern.

10. The passive radiator mechanism according to claim 1, wherein the plurality of passages correspond with the at least two protruding portions one to one.

11. The passive radiator mechanism according to claim 10, wherein a shape of a projection contour of a passage on the first surface is adapted to that of a projection contour of a protruding portion on the first surface.

12. The passive radiator mechanism according to claim 11, wherein the passage is a through hole formed on the protective cover, and there is a gap between an inner wall of the through hole and a peripheral wall of the protruding portion.

13. The passive radiator mechanism according to claim 2, wherein the passive vibration plate is configured to drive the at least two protruding portions to move to a third position, wherein at the third position, an end surface, away from the passive vibration plate, of a protruding portion is flush with an end surface, away from the passive vibration plate, of a passage, and wherein the third position is between the first position and the second position.

14. The passive radiator mechanism according to claim 1, wherein the passive vibration plate comprises a light-transmitting material component, and/or the at least two protruding portions comprise a light-transmitting material component.

15. The passive radiator mechanism according to claim 14, wherein the passive vibration plate further has a second surface opposite to the first surface, and wherein the passive radiator assembly further comprises a light source mounted on the second surface.

16. The passive radiator mechanism according to claim 1, wherein a passage of the plurality of passages is a through hole formed on the protective cover, and there is a gap between an inner wall of the through hole and a peripheral wall of a protruding portion of the at least two protruding portions, and wherein when the protruding portion passes through the through hole, there is a gap between the inner wall of the through hole and the peripheral wall of the protruding portion to facilitate a movement of the protruding portion within the through hole.

17. The passive radiator mechanism according to claim 16, wherein the protective cover comprises a cover body and separators, the cover body is provided with an opening, the separators are arranged at an opening and connected to the cover body, the separators separate the opening to form the plurality of passages, and wherein there is a gap between the peripheral wall of the protruding portion and the separators as well as an inner wall of the opening.

18. A speaker box, comprising an active acoustic unit and a passive radiator mechanism comprising:
a passive vibration plate having a first surface and plurality of protruding elements extending from the first surface; and
a protective cover disposed outside the passive vibration plate, the protective cover provided with a plurality of separator elements defining passages therebetween,
wherein during at least one state of use, the protruding elements of the passive vibration plate extend into respective passages in the protective cover forming an interlaced relationship.

19. The speaker box according to claim 18, further comprising at least four protruding elements and at least four separator elements and wherein the protruding elements and the separator elements are parallel to each other.

20. The speaker box according to claim 18, wherein during a second state of use, the protruding elements do not extend into the respective passages.
